(19) United States
(12) Patent Application Publication
(10) Pub. No.: US 2015/0281333 A1
(43) Pub. Date: Oct. 1, 2015

(54) Method and Apparatus for Delivering GUI Applications Executing on Local Computing Devices to Remote Devices

(71) Applicant: Reddo Mobility, Cambridge, MA (US)

(72) Inventors: Eyal Albert, Raanana (IL); Shlomi Bin, Hod Ha'Sharon (IL); Eyal Karpel, Hadera (IL); Yitshak Spitzen, Newton (US); Tal Tikotzki, Ramat Gan (IL); Eugene Kuznetsov, Somerville, MA (US)

(73) Assignee: Reddo Mobility, Cambridge, MA (US)

(21) Appl. No.: 14/542,446

(22) Filed: Nov. 14, 2014

Related U.S. Application Data
(60) Provisional application No. 61/970,438, filed on Mar. 26, 2014.

(51) Int. Cl. H04L 29/08; G06F 17/21; G06F 17/24; G06F 3/0484

(52) U.S. Cl. CPC H04L 67/10; G06F 3/0484; G06F 17/211; H04L 67/34; G06F 17/24

(57) ABSTRACT

A method for delivering an existing GUI application executing on a local computing device to a remote device where application flow and/or user experience of the existing GUI application is customized to match constraints of the remote device includes providing an agent that deconstructs the existing GUI application on the local computing device in order to create an application representation model that describes the existing GUI application on the local computing device. An application definition is created by visually editing an application flow and/or user experience via real time interception of the existing GUI application to match constraints of the remote device. The existing GUI application transformed by the application definition is delivered to the remote device utilizing a native widget toolkit of the remote device.

### RELATED APPLICATION SECTION

The present application is a non-provisional application of U.S. Provisional Application Ser. No. 61/970,438, filed on Mar. 26, 2014, entitled Project Igloo and EMS Breakdown. The entire contents of U.S. Provisional Patent Application No. 61/970,438 are herein incorporated by reference.

### DEFINITIONS

A “GUI application” is herein defined as a software application that allows a user to interact with it through various graphical icons and visual indicators.

An “existing GUI application” is herein defined as an application that performs its computation logic using a CPU of the device providing its user interface.

A “local computing device” is herein defined as a local computing device capable of executing a GUI application.

A “remote device” is herein defined as a computing device that renders a GUI application and processes user interactions from one or more input devices.

The term “visual editing” is herein defined as providing a What You See is What You Get (WYSIWYG) interface that allows the user to customize the existing GUI application.

The term “application flow” is herein defined as the systematic organization of GUI components, screens, data, actions, events and mappings to business logic.

The term “constraints” are herein defined as characteristics of the remote device that restrict the existing GUI application from being rendered in its original form on the remote device. Examples of some common constraints are screen size, screen resolution, single document interface, shorter battery life, slower processor speeds, less available memory, slower network connectivity, data entry capabilities, and limited input options, such as no keyboard or mouse, etc.

An “agent” is herein defined as a software application that intercepts the existing GUI application and manages graphical changes, user interaction, such as mouse clicks, and user inputs, such as keyboard events.

The term “look and feel” is herein defined as the design elements of a GUI, such as colors, shapes, sizes, fonts and other observables and user's behavior of dynamic GUI components, such as buttons, text fields, and menus.

The term “layout” is herein defined as the visual structure for a user interface. For example, in a window, the visual structure describes how the child objects are organized with respect to the parent window and to each other. The visual structure can be defined by fixed values of x,y offsets from a certain position, from positions relative to each other, or from positions based on the available space. The visual structure can be generally arranged in a vertical or horizontal list, or arranged in a grid of rows and columns.

The term “application definition” is herein defined as a template containing all the metadata necessary to transform the original GUI application where the transformations are defined by the user in the visual editor and rendered to a remote device.

The term “application representation model” is herein defined as a set of data that describes the entire graphical user interface of the existing GUI application where each data element can have properties, such as text, size, color, location, actions and events.

The term “widget” is defined herein as a graphical control element in a graphical user interface (GUI).

The term “widget toolkit” is defined herein as a set of libraries containing graphical control elements in a GUI.

The term “real time interception” is defined herein as decomposing the original GUI application through the use of operating system application program interfaces (APIs), and then displaying the GUI application in real time for editing by the user.

### DESCRIPTION OF THE DRAWINGS

The present teaching, in accordance with preferred and exemplary embodiments, together with further advantages thereof, is more particularly described in the following detailed description, taken in conjunction with the accompanying drawings. The skilled person in the art will understand that the drawings, described below, are for illustration purposes only. The drawings are not necessarily to scale, emphasis instead generally being placed upon illustrating principles of the teaching. The drawings are not intended to limit the scope of the Applicant's teaching in any way.

FIG. 1 illustrates a block diagram of one embodiment of a method for customizing existing GUI applications to match constraints of remote devices and delivering existing GUI applications to the remote devices according to the present teaching.

FIG. 2A illustrates an embodiment of an existing GUI application.

FIG. 2B illustrates an embodiment of an Application Representation Model, which is an abstract representation of the graphical user interface of the existing GUI application.

FIG. 2C illustrates the delivery of the existing GUI application shown in FIG. 2A to a remote computing device.

FIG. 3 illustrates a block diagram of a method of intercepting an existing GUI application, managing the program state and then delivering to the remote device according to the present teaching.

FIG. 4 illustrates a block diagram of a method of a particular embodiment of the present teaching where existing GUI applications are executed within a Citrix virtualization environment and delivered to a remote device.

FIG. 5 illustrates a block diagram of a method of a particular embodiment of the present teaching where existing GUI applications are executed within a VMware Horizon Virtualization Environment and delivered to one or more remote devices though an external and/or internal network.

FIGS. 6A and 6B illustrate an example of visually editing the application flow of the existing GUI application to generate an application definition targeted to a particular remote device.

FIG. 7 illustrates a diagram of how various application definitions can be used according to the methods and apparatus of the present teaching.

FIG. 8 illustrates a block diagram of a method of a particular embodiment of the present teaching where components from multiple existing GUI applications are “mashed up” to create one application definition.

### DESCRIPTION OF VARIOUS EMBODIMENTS

Reference in the specification to “one embodiment” or “an embodiment” means that a particular feature, structure, or characteristic described in connection with the embodiment is included in at least one embodiment of the teaching. The appearances of the phrase “in one embodiment” in various places in the specification are not necessarily all referring to the same embodiment.

It should be understood that the individual steps of the methods of the present teachings may be performed in any order and/or simultaneously as long as the teaching remains operable. Furthermore, it should be understood that the apparatus and methods of the present teachings can include any number or all of the described embodiments as long as the teaching remains operable.

The present teaching will now be described in more detail with reference to exemplary embodiments thereof as shown in the accompanying drawings. While the present teachings are described in conjunction with various embodiments and examples, it is not intended that the present teachings be limited to such embodiments. On the contrary, the present teachings encompass various alternatives, modifications and equivalents, as will be appreciated by those of skill in the art. Those of ordinary skill in the art having access to the teaching herein will recognize additional implementations, modifications, and embodiments, as well as other fields of use, which are within the scope of the present disclosure as described herein.

Mobile and other portable devices are widely used by most individuals and businesses in the modern world. Modern business organizations are experiencing an increased demand from employees, and other end users, for “bring your own device” (BYOD) support. Today, employees are likely to have at least one mobile device, such as a smartphone or tablet, on their persons at all times. It is highly desirable to provide these employees with access to business enterprise software applications directly from their mobile devices. Such access will greatly improve business productivity.

However, most existing desktop personal computer based software applications are not easily accessed or manipulated from mobile devices. In fact, many of the desktop software applications that are most critical to business operations are difficult or impossible to access with mobile devices. There is a very significant need in the industry to provide organizations with the ability to deliver their existing business desktop applications to a multitude of different mobile and portable devices. Such delivery must be implemented in a manner where the user can interact with the original application in an intuitive and native manner.

Some enterprise software applications have been designed with features that are easily ported to mobile and portable devices. Many of these software applications provide access through native mobile applications for particular platforms, such as iOS, Android etc., or through mobile browser (HTML5) based portals. However, these mobile versions require constant maintenance and synchronization to guarantee that mobile users have the same feature set as the desktop users of the application. Such maintenance significantly adds to the cost of the software and requires companies to expend more IT resources.

Furthermore, many business organizations have numerous legacy applications that are critical to day-to-day operations. Typically, these software applications have limited or no mobile interface support and require a significant software development effort to add support for a multitude of mobile and portable devices.

One known approach to providing support for mobile and portable devices is to simply stream the desktop application to the mobile device with no changes to the user interface or user experience. This approach is generally unworkable for most businesses because desktop applications are designed for keyboard and mouse interfaces, while mobile devices are designed for touch input on a much smaller screen.

Another known approach to providing support for mobile and portable devices is to internally develop software for a new mobile application that runs natively on the target devices. This approach is undesirable because the source code is typically required and it almost always requires significant software architecture and development resources, as well as a new support system to maintain the same feature set as the original application. Thus, this approach is usually cost prohibitive.

Current solutions to the problem of providing users of mobile and portable devices with full feature access to many desktop software applications do not create an application representation model that can easily be visually edited by providing a real time view of the existing application. In addition, these current solutions do not allow the user to easily manipulate the GUI components or existing GUI application so that they are presented in a desirable or optimized format for the remote device.

Some known methods use transformation services designed to optimize certain graphical components, such as aggregation, reduction, rearrangement, overflow, mashup, or zoom service, for remote devices. However, these services do not allow the user to visually transform the existing GUI application by directly editing the graphical components in a What You See Is What You Get environment via a drag and drop, or other user-friendly methodology.

Today, business organizations are looking to easily mobilize their existing desktop software applications through systems that provide mobile experience virtualization (MXV). MXV optimizes the existing desktop applications' interfaces for end user devices, taking into account physical screen size, resolution, touch interface and native look and feel. These systems have simple interfaces and give the user the ability to customize and optimize the screen without requiring any software development skills. Furthermore, these systems can deliver existing desktop applications to mobile clients in a timely and cost effective manner.

One feature of the methods and apparatus of the present teaching is the existing GUI application can be rendered on the remote device using a native web browser. This feature is advantageous for some applications because custom applications are not needed. Furthermore, through the use of HTML 5 elements, the transformed application achieves the look and feel of a native application executing on the remote device.

Another feature of the methods and apparatus of the present teaching is that methods and apparatus perform real time interception of an existing GUI application by decomposing the original GUI application through the use of operating system APIs, and then displaying the GUI application in real time for editing by the user. As new widows are opened in the existing GUI application, they will be immediately available for customizing their graphical components for a remote device. Such a feature is efficient and easy to use, and does not require software development.

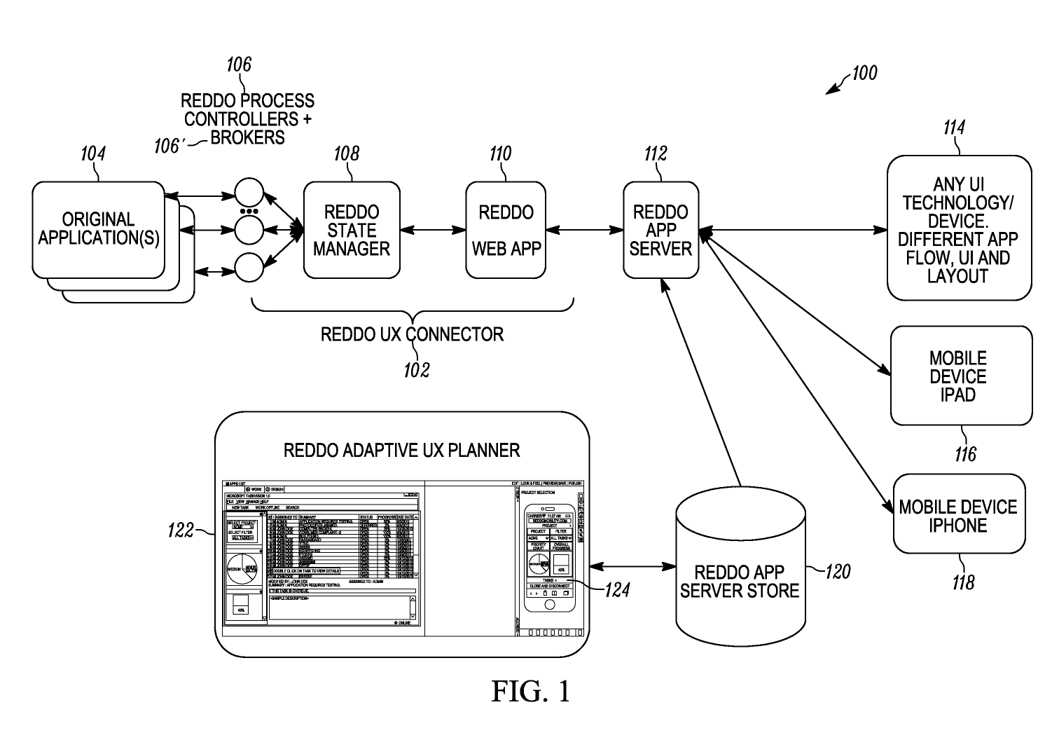

FIG. 1 illustrates a block diagram 100 of one embodiment of a method for customizing existing GUI applications to match constraints of remote devices and delivering existing GUI applications to the remote devices according to the present teaching. An Existing GUI Application 104 executes on a desktop computing device, such as a desktop computing device running the Windows operating system. However, one skilled in the art will appreciate that the methods and apparatus of the present teaching are not dependent upon any particular operating system.

The Reddo UX Connector 102 intercepts the Existing GUI Application 104 and provides bi-directional communication between the Remote Devices 114, 116, and 118 and the Existing GUI Application 104, thereby enabling the delivery of the Existing GUI Application 104. The term “delivering the existing GUI application” is herein defined as performing the following steps: (1) rendering the GUI in whole or in part based on the application definition; (2) capturing user interactions/actions from the remote device such as clicks, keyboard entry, mouse movement and executing the interaction/action in the existing application. A simple example of delivering the existing GUI application is that if a button is pressed on the remote device, that action will be executed in the existing application.

In order to provide a highly productive user experience when delivering the Existing GUI Application 104 to a remote device, the interception and communication must include data describing both the graphical elements and events they generate. One feature of the present teaching is that data describing both the graphical elements and events can be provided with the Reddo UX Connector 102 that uses low-level operating system hooks to retrieve necessary information from a widget toolkit.

In many modern operating systems, GUI applications are created using one or more frameworks referred to as widget toolkits. A widget toolkit is a set of libraries containing graphical control elements, which are referred to in the art as widgets. A software developer utilizes appropriate widgets and arranges them in windows or screens while building the GUI application. The individual widgets can vary in shapes, sizes and complexity, but the toolkit's objective is to facilitate a Graphical User Interface, instead of a command line interface where commands are fed to the system one at a time. Modern widget toolkits contain components, such as forms for entering text data, buttons for initiating actions and grids for displaying tabular data. Many widget toolkits allow a user to interact with the graphical system by using event-driven programming. When a user initiates an event, such as a button click, it is detected and passed to the underlying application. The application performs one or more actions based on the event, and can update the screen to allow more user interaction.

The two types of widget toolkits generally found in modern software systems are called low-level and high-level widget toolkits. Low-level widget toolkits are either integrated directly into the operating system or run as a separate layer on top of the operating system. Low-level widget toolkits are tightly coupled with the host operating system, and traditionally have a speed advantage because of a lack of abstraction when being executed. Low-level widget toolkits are closely tied to particular operating systems. Examples of widely used low-level widget toolkits include the Windows API used in Microsoft Windows, Cocoa toolkit used in Apple Mac OS X and the XLib (also known as libX11) used in the Linux operating system.

High-level widget toolkits abstract each individual component and allow a GUI to be executed on multiple platforms. Each low-level toolkit contains slightly different widgets, but a high-level toolkit must contain a superset of available widgets and map them to each corresponding widget within an operating system. For example, the Swing toolkit found within Java can execute the same GUI application on Windows, Mac OS X, and Unix/Linux operating systems.

The Reddo UX Connector 102 includes several sub components, including the Process Controller 106 and Broker 106′, the State Manager 108 and the Reddo Web App 110. The Process Controller 106 is a software program executed on the desktop computing device and is connected to the Existing GUI Application 104 through inter-process communication. In this embodiment, the Process Controller 106 receives commands from the Broker 106′ through a socket connection and executes that command on the Existing GUI Application 104. For example, the Process Controller 106 can receive commands to invoke the Existing GUI Application 104 or to execute a mouse click on a particular GUI element. The Process Controller 106 also monitors the program state, GUI interface and events within the Existing GUI Application 104, and reports program state, GUI interface and events to the Broker 106′. For example, if a GUI element within the Existing GUI Application 104 has changed state and an event is fired, the Process Controller 106 can relay both the GUI element status and the event information to the Broker 106′.

The Broker 106′ is a software program executed on the desktop computing device that provides bi-directional communication of messages between the State Manager 108 and one or more Process Controllers 106. For example, the Broker 106′ can receive a message from Process Controller 106 that a GUI element within the Existing GUI Application 104 has changed state. The Broker 106′ relays the message to the State Manager 108. Also, the Broker 106′ can receive messages from the State Manager 108, process the message, and then send it to the corresponding Process Controller 106. For example, the Broker 106′ can receive a message that a user has made a selection within a grid GUI element displayed in Existing GUI Application 104. The Broker 106′ can send the message to the corresponding Process Controller 106 for further processing.

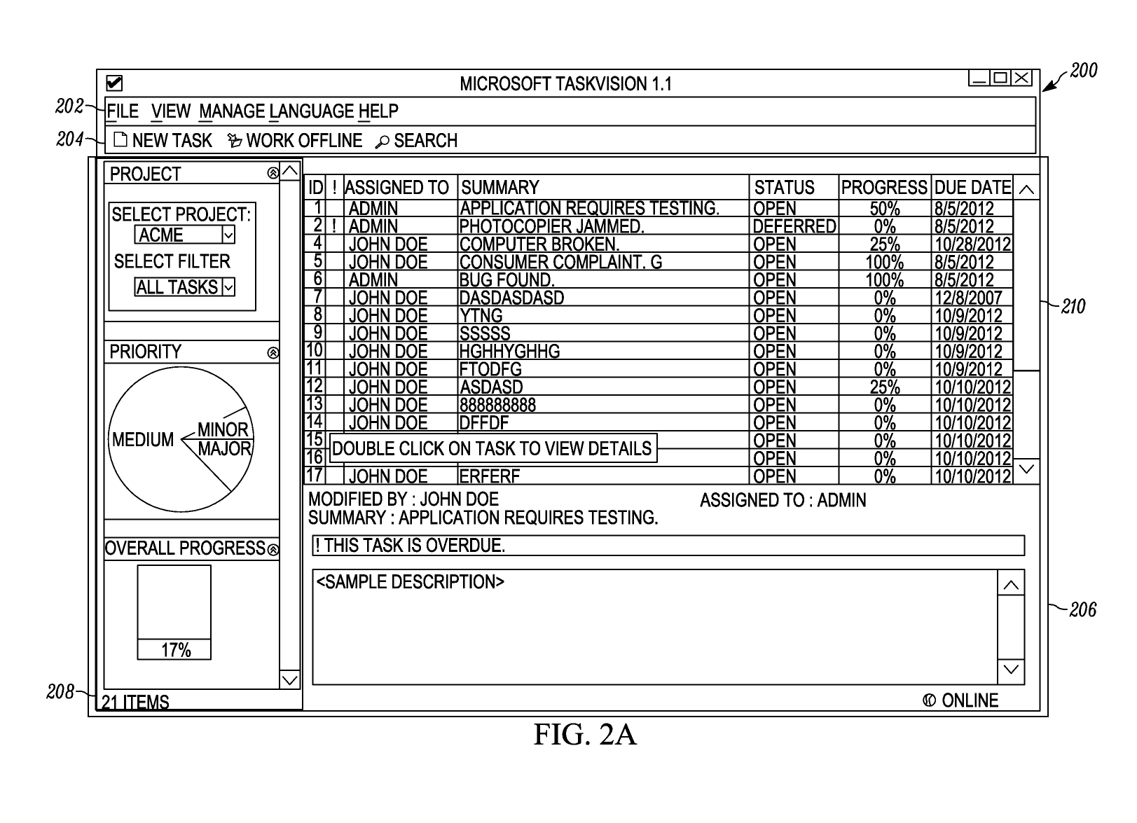

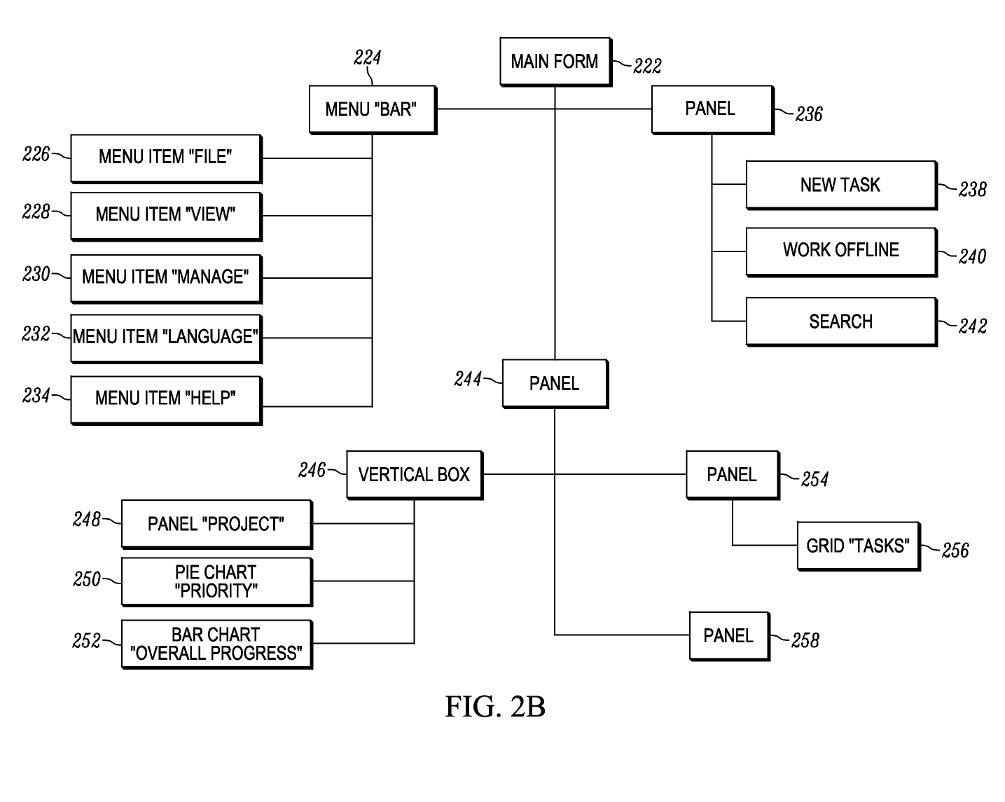

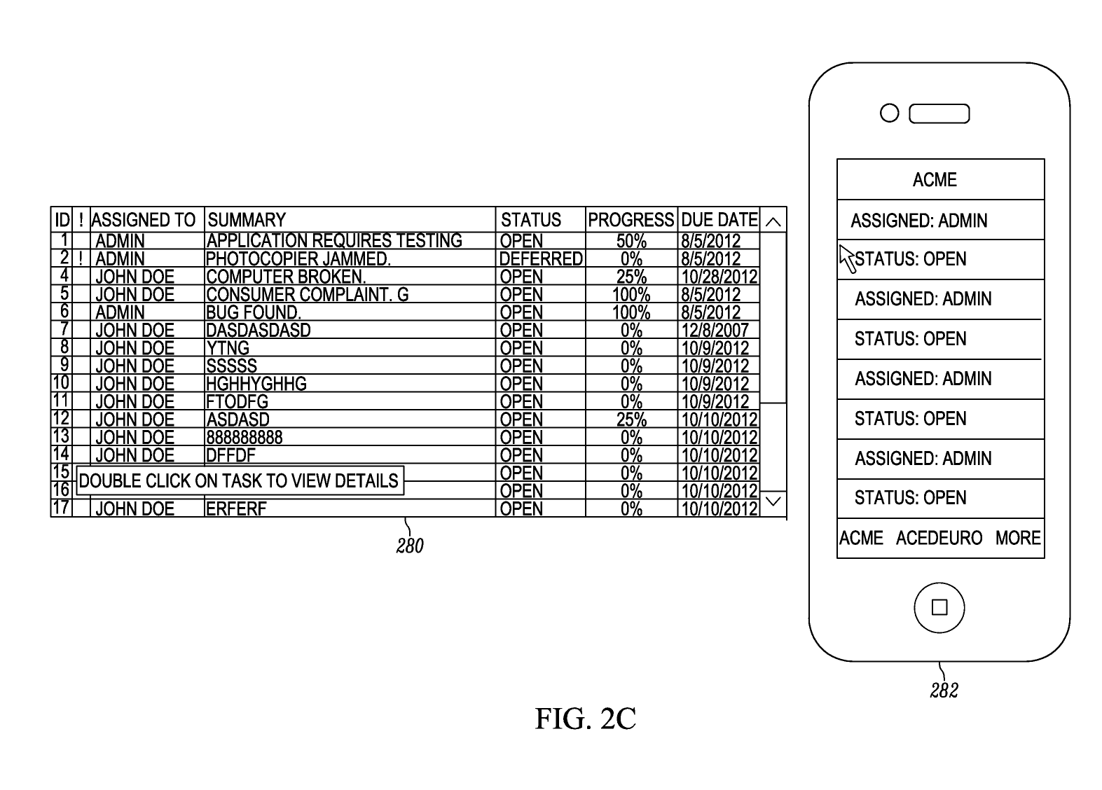

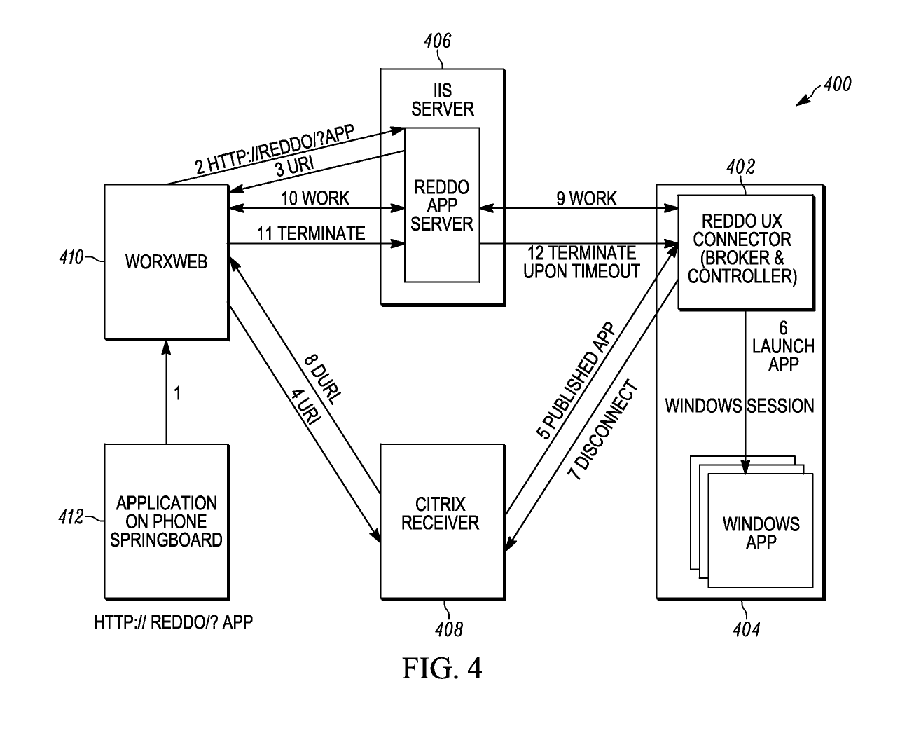

The State Manager 108 is a software program that stores and synchronizes the application representation model for a plurality of Existing GUI Applications 104, and provides for bi-directional communication between the Reddo Web App 110 and one or more Brokers 106′. The State Manager 108 is described in further detail in connection with FIG. 4. The application representation model is described in further detail in connection with FIG. 2B.

The Reddo Web App 110 is a software application that executes within the Reddo App Server 112 and renders one or more Existing GUI Applications 104 to one or more remote devices. The Reddo Web App 110 communicates user interactions initiated within the delivered GUI application to the Reddo State Manager 108. Furthermore, the Reddo Web App 110 receives messages from the Reddo State Manager 108 and updates the rendered application on the remote device.

The Reddo App Server 112 is a software application server that executes the Reddo Web App 110 and executes the Reddo App Server Store 120. The Reddo App Server Store 120 is a software database that contains one or more application definitions. The application definitions are created, edited, saved and removed by the Reddo Adaptive UX Planner 122, and are retrieved for use by the Reddo Application Server 112. For example, Reddo App Server Store 120 can contain the application definition for an existing application targeted for the remote mobile device. If a connection from the remote mobile device is established to the Reddo Web App 110, the remote mobile device is identified and the corresponding application definition is retrieved from the Reddo App Server Store 120. The Reddo App Server 112 can then deliver the Existing GUI Application 104 to the remote mobile device 116, 118.

The UX Reddo Adaptive UX Planner 122 allows a user to select the target device from a list where the user of the Planner 122 can drag and drop components from the Existing GUI Application 104 into a graphical representation of the remote device. This allows the user to add one or more screens to optimize application flow, change look and feel of certain components to make them more accessible on the remote device and add new components that did not exist in the Existing GUI Application 104. Once the user of the Planner 122 has achieved desired functionality, the application definition is saved to the Reddo App Server Store 120. When a remote device, such as the iPhone 124, shown as an image of an iPhone in the Reddo Adaptive UX Planner 122, connects to the Reddo App Server 112 and requests an existing application, it is identified as an Apple iPhone device and the application definition is then retrieved. The user is able to interact with the existing GUI application through the use of a standard web browser running on a personal computer through an optimized interface targeted for the iPhone mobile device.

FIGS. 2A, 2B and 2C describe the methodology for delivering an existing GUI application through the use of an application representation model to a remote computer device. FIG. 2A illustrates an embodiment of an existing GUI application. In this embodiment, the existing GUI application is an instance of Microsoft TaskVision, a commercially available software application that is commonly used for project management tasks. One skilled in the art will appreciate that the present teaching is not limited to any particular existing GUI application.

FIG. 2B illustrates an embodiment of an application representation model, which is an abstract representation of the graphical user interface of the existing GUI application. In the embodiment shown in FIG. 2B, the application representation model is a tree structure with each node representing a component of the existing GUI application. Each link between nodes represents a parent-child relationship. This tree structure is commonly used in modern GUI widget frameworks, which were described in connection with FIG. 1. The root node of the application representation model is the main form. It contains the title of the application, as well as buttons for minimizing, maximizing and closing the program. Each child node can contain one or multiple child nodes. Each child node can also be a leaf node, which is a node that contains no additional child nodes.

In the specific embodiment illustrated in FIG. 2B, the Main Form Node 222 contains three child nodes, the Menu Bar Node 224, the Panel Node 236 and the Panel Node 244. The Menu Bar Node 224 corresponds to the Menu Bar Widget 202 illustrated in FIG. 2A, and contains 5 child nodes, which represent the clickable menu items File 226, View 228, Manage 230, Language 232 and Help 234. A menu bar is a GUI widget that provides a hierarchical tree of menu items for quick user access with a mouse or keyboard input. A user first clicks on a top-level menu item, and is then presented with one or more menu items in the next level. The user can make a selection or continue to select other menu items that expand to the next level in the menu tree. The user may also initiate a menu by clicking a keyboard shortcut, such as the commonly found ALT-F command to open the File menu on a Windows system.

The Menu Bar Widget 202 (FIG. 2A) is unsuitable for direct display on mobile devices, such as mobile phones or tablets, for two reasons. The first reason is that these devices lack a physical keyboard or mouse and instead rely on touch input for keyboard and ‘click’ operations. The second reason is that these devices have a limited horizontal and vertical screen resolution, and thus cannot fit a deep menu tree in a single screen. In a modern mobile graphical user interface, each menu level is displayed on a separate screen. Selecting a menu item renders the next screen containing the next level in the menu tree. A user can create an application definition through the use of the Reddo UX Connector 122 (FIG. 1) that will render a desktop menu widget into a highly optimized menu widget on a target device, such as a mobile phone or tablet.

The Panel Node 236 shown in FIG. 2B corresponds to the Panel Widget 204 illustrated in FIG. 2A. A Panel is a Widget that is used to encapsulate one or more Widgets within its bounding box. The Panel Node 236 shown in FIG. 2B contains three child nodes, which represent the clickable buttons New Task 238, Work Offline 240 and Search 242. Since the primary purpose of a Button Widget is to have a user click on it, the action or event that the program takes when a button is clicked is intercepted and stored within the corresponding node of the particular application representation model.

The Panel Node 244 corresponds to the Panel Widget 206 illustrated in FIG. 2A. Panel Node 244 contains Vertical Box Node 246, and Panel 254. Vertical Box Node 246 contains 3 child nodes, which represent the Project Panel Node 248, Priority Pie Chart Node 250 and Bar Chart Overall Progress Node 252. Pie Chart Widgets are essential to delivering existing GUI applications to a remote mobile device. Nevertheless, Pie Chart Widgets are relatively difficult Widgets to render on a remote mobile device. Both the underlying chart data, as well as the chart type (pie, bar, line, etc.), are intercepted from the existing GUI application, stored in the application representation model, and then rendered on the remote device. For example, when delivering an existing GUI application to a device interpreting HTML 5, basic GUI Widgets, such as a Text Box Widget, Button Widget or Label Widget have an equivalent within HTML. However, Chart Widgets have no such equivalent in HTML 5. Chart Widgets can be redrawn using an HTLM 5 Canvas element.

Panel Node 254 contains one child node that represents Grid Node Tasks 256. Grid Node Tasks 256 correspond to the Grid Widget 210 that is illustrated in FIG. 2A. The Grid Widget 210 is optimized for a desktop screen and contains numerous columns, requiring a considerable amount of horizontal screen real estate. The original Grid Node Task 256 shown in FIG. 2A is unsuitable for direct display on a mobile computing device, such as the iPhone.

FIG. 2C illustrates the delivery of the existing GUI application 208 shown in FIG. 2A to a remote computing device. One skilled in the art will appreciate that delivery can be performed to any type of computing device, and that the present teachings are not limited to mobile computing devices. In particular, FIG. 2C shows that in this example, a Task List 280 from the existing GUI application has been delivered to an iPhone 282. The Apple iPhone is running the known Safari web browser application. FIG. 2A shows the Task Grid 204 in its original view from the Task List 280 of the existing GUI application (FIG. 2C). The Task Grid 204 shown in FIG. 2A is optimized for a desktop screen and contains numerous columns, requiring a considerable amount of horizontal screen real estate. The original Task Grid 204 shown in FIG. 2A is unsuitable for direct display on a mobile computing device, such as the iPhone 282 shown in FIG. 2C, because of the very different dimensions and layout of the respective visual displays. For example, if Task Grid 204 for the desktop screen shown in FIG. 2A was rendered on the iPhone screen and zoomed out to fit the horizontal dimension of the iPhone 282 screen, the text size would not be readable by a user.

The Reddo Adaptive UX Planner 122 (FIG. 1) is used to transform the original Task Grid 204 shown in FIG. 2A into a highly usable grid suitable for rendering on the iPhone mobile device 282 shown in FIG. 2C. In some embodiments, the mobile grid on the iPhone can be optimized by arranging the columns vertically within each row of the grid. This eliminates the need for horizontal scrolling, and is similar to the native iPhone grid found within the Apple operating system. This allows the user to intuitively scroll through the optimized list just as if they were using a native iOS application. In some embodiments, the grid is rendered in its original form without any zoom. In these embodiments, the user would have to scroll horizontally in order to view all the columns contained in one row of data.

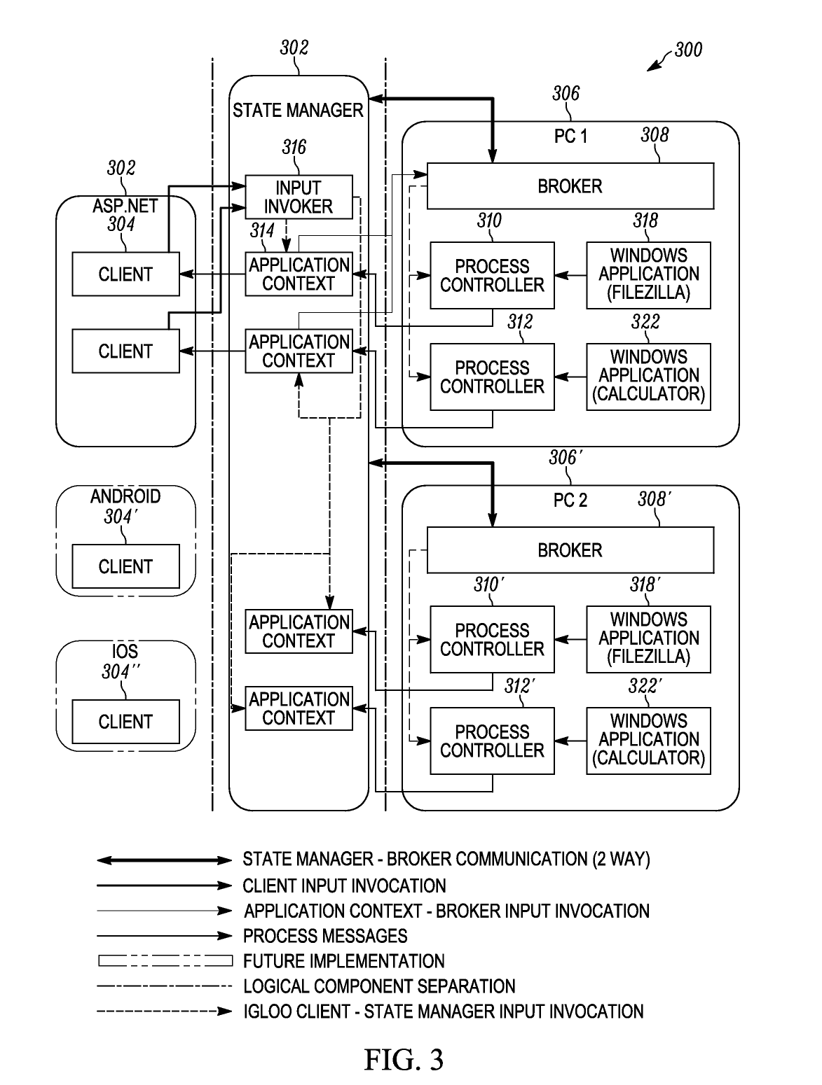

FIG. 3 illustrates a block diagram 300 of a method of intercepting an existing GUI application, managing the program state, and then delivering to the remote device according to the present teaching. Referring to FIGS. 1 and 3, the block diagram 300 shows a State Manager 302 that facilitates communication between one or more clients 304, 304′, and 304″ and one or more computing devices, shown in FIG. 3 as personal computers PC 1 306 and PC 2 306′. Personal Computer PC 1 306 is a computing device that executes Broker 1 308, Process Controller 1 310 and Process Controller 2 312. In various embodiments, the operating system of PC 1 306 can operate within a native operating system environment or a virtualized operating system environment. The Process Controller 1 310 is responsible for initializing an existing GUI application, processing messages from the existing GUI application and sending client input to the existing GUI application.

The State Manager 302 facilitates bidirectional communication with the clients via Application Context 314 and receives user interactions from the Clients 304, 304′ via the Input Invoker 316. The Application Context 314 stores the particular application representation model for the existing GUI application. In addition, the Application Context 314 sends changes within the existing GUI application to the appropriate Clients 304, 304′ and also sends user input from the Input Invoker 316 to the appropriate Broker 308, 308′.

Clients 304 executes within an ASP.NET Container 324. For example, Client 304 can deliver an application definition of the Existing GUI Application FileZilla 318 through Application Context 314 and Input Invoker 316. An embodiment of a method of delivery of an Existing GUI Application Calculator 322 according to the present teaching is as follows: Client 304 first establishes a connection to web server ASP.NET where Client 304 is a remote computing device for which an application definition residing in the Application Context 314 was targeted. The current state of executing the GUI Application Calculator 322 is then rendered on Client 304.

Client 304 then begins to interact with the Existing GUI Application Calculator 322. The user initiates by sending an input event, such as a tap, click or keystroke. The resulting Client Input is then sent to the Input Invoker 316 executing within the State Manager 302. The Client Input invocation includes the event metadata as well as the associated identifying information of the Application Context 314.

The Input Invoker 316 then passes the input event to Application Context 314, which then processes the event, updates the application representational model and sends the event to Broker 308. Broker 308 sends the event to the Process Controller 310 that originally executed the Existing GUI Application Calculator 322. The Process Controller 310 simulates user input on the Existing GUI Application Calculator 322. The Existing GUI Application Calculator 322 then responds to the user input in the same manner as a direct user interaction.

Process Controller 318 then sends all changes to the Application Context 314 after the existing GUI application has responded to user input. The Application Context 314 updates the application representational model and the current state of existing GUI application is rendered on Client 304 via web server ASP.NET 324.

FIG. 4 illustrates a block diagram 400 of a method of an embodiment of the present teaching where existing GUI applications are executed within a Citrix virtualization environment and delivered to a remote device. The Citrix virtualization environment is widely used and increasing in popularity because it is relatively easy to use and well supported. One feature of the Citrix virtualization environment is that it can simultaneously execute a plurality of GUI applications.

Referring to both FIGS. 1 and 4, the Reddo UX Connector 102, 402 executes within the Citrix virtualized environment along with the one or more Existing GUI Applications 104, 404. The Reddo UX Connector 102, 402 interfaces the Existing GUI Application 104, 404 and the Reddo Application Server 112, 406. The Citrix Receiver 408 interfaces with Citrix WorxWeb 410 to facilitate a secure communication channel between all components. The Citrix Receiver 408 is client software that provides easy access to known XenDesktop and XenApp installations. Citrix WorxWeb 410 is a native secure browser for iOS and Android devices that enables secure access to internal network resources, such as HTML5 web applications. Citrix WorxWeb 410 is designed to look and feel like a native browser while seamlessly providing secure SSL Intranet connectivity without prompting the user for additional passwords to manually launch a VPN. The Existing GUI Applications 404 are delivered to one or more Remote Devices 412 through the use of the Citrix components.

More specifically, referring to the block diagram 400, the method of an embodiment of the present teaching where existing GUI applications are executed within a Citrix virtualization environment and delivered to the remote device 412 is as follows. The remote device 412 indicates to Citrix WorxWeb 410 the application that it desires to be delivered. Citrix WorxWeb 410 then communicates the desired application to the Redo Application Server 406. The Redo Application Server 406 generates a Uniform Resource Locator (URL) address and transmits the URL address back to the Citrix WorxWeb 410. The Citrix WorxWeb 410 then transmits it to the Citrix Receiver 408.

The Citrix WorxWeb 410 then publishes the desired application to the Reddo UX Connector 402 that includes the controller 106 and the Broker 106′ that were described in connection with FIG. 1. The Reddo UX Connector 402 then launches desired existing GUI application. In the embodiment shown in FIG. 4, the desired GUI application is a GUI application executing in a Microsoft Windows environment. The Citrix Receiver 408 is then disconnected because it is no longer needed. One skilled in the art will appreciate that the Citrix Receiver 408 adds a layer of abstraction that is needed to start the methods of the present teaching. The Citrix WorxWeb 410 software allows the Reddo UX Connector 402 to communicate with the Reddo Application Server 406 and deliver the existing GUI application to the remote device 412 according to the present teaching.

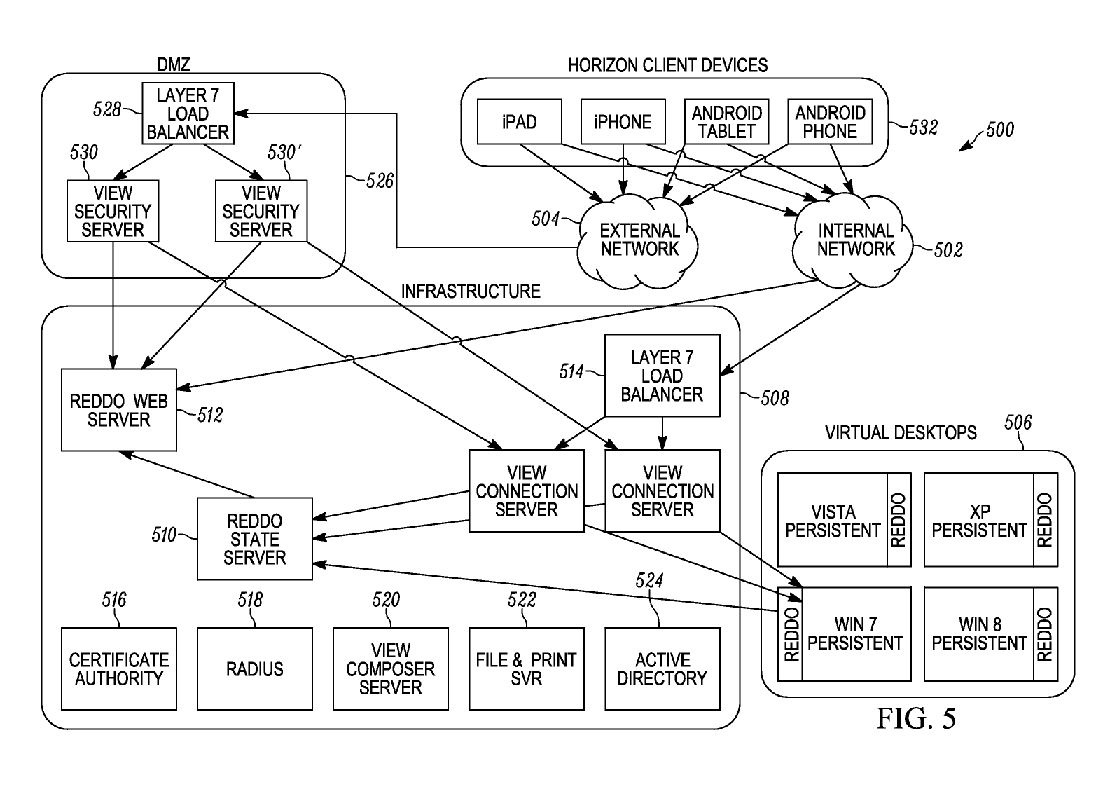

FIG. 5 illustrates a block diagram 500 of a method of an embodiment of the present teaching where existing GUI applications are executed within a VMware Horizon virtualization environment and delivered to one or more remote devices though an internal 502 and/or external network 504. If the original GUI application is delivered through an external network 504, the VMware Horizon virtualization environment adds an additional layer of security to the methods and apparatus of the present teaching.

The existing GUI applications are shown as virtual desktops 506 operating within the VMware Horizon virtualization environment. Various virtual desktops 506 are shown running different Microsoft Windows operating systems, such as Windows XP, Windows Vista, Windows 7 and Windows 8. The various virtual desktops 506 communicate with infrastructure hardware 508 running the VMware Horizon virtualization environment. Referring to both FIGS. 1 and 5, the infrastructure hardware 508 includes the Reddo State Manager 510 that communicates with virtual desktops 506 and that also communicates with the Reddo Web Server 512. The infrastructure hardware 504 can also include other enterprise software infrastructure components, such as a Load Balancer 514, Certificate Authority 516, Radius Authentication Server 518, View Composer Server 520, File and Print Server 522 and Active Directory 524.

The Reddo Web Server 512 communicates with the internal network 502 directly and with the external network 504 via a Demilitarized Zone (DMZ) 526. The DMZ 526 can include software components, such as the Load Balancer 528 and View Security Servers 530, 530′ that manage access to the virtual desktops 506.

Various Remote Devices 532, such as iPads, iPhones, Android Tablets, and Android Phones, are supported by the VMware Horizon virtualization environment. These devices execute a VMware Horizon native application to gain access to the virtualization environment. These devices can communicate directly with the internal network 502 and can communicate with the external network 504.

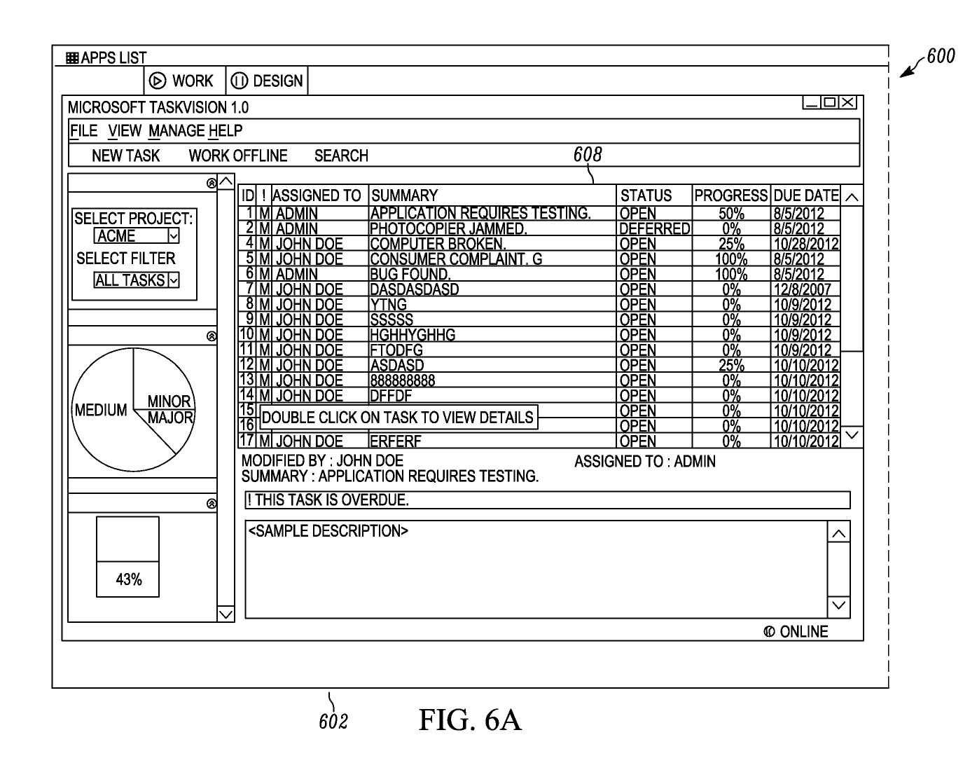

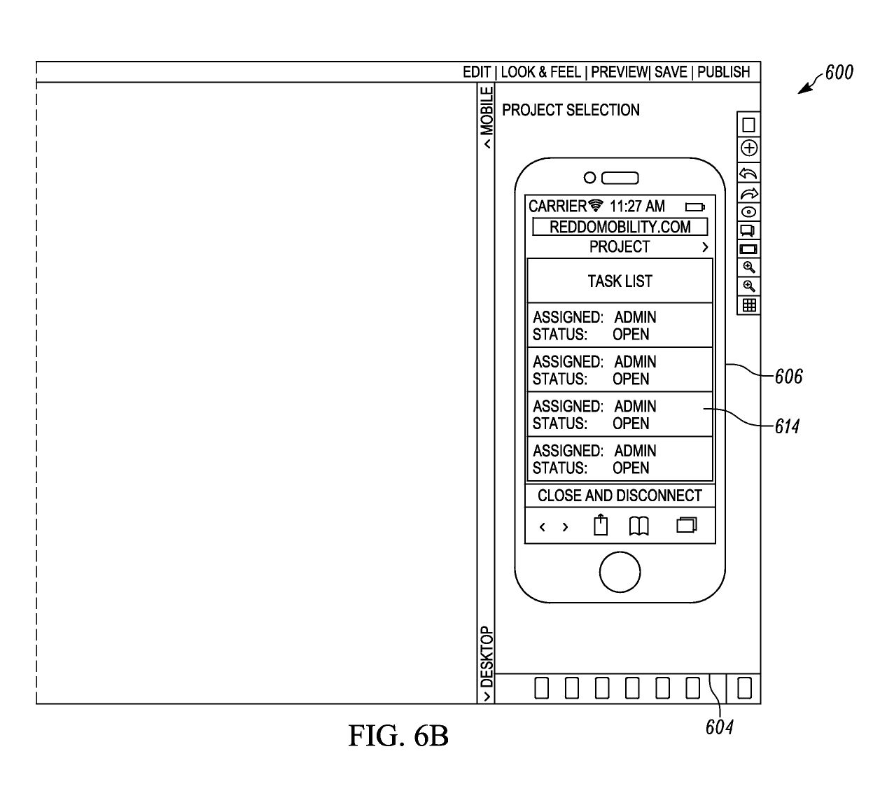

FIGS. 6A and 6B illustrate visually editing the application flow of the existing GUI application to generate an application definition targeted to a particular remote device in an embodiment of the present teaching. More specifically, FIGS. 6A and 6B illustrate a Visual Editor 600 referred to herein as Reddo Adaptive UX Planner that was described in connection with the method illustrated in FIG. 1 for customizing existing GUI applications to match constraints of remote devices and to deliver to the remote devices. The Visual Editor 600 is used to customize the existing GUI application according to the present teaching.

Referring to the left side of the Visual Editor 600 screen in FIG. 6A, the editor 600 includes the current view of the Existing GUI Application 602 that is decomposed into its application representation model. One aspect of the present teaching is that through the use of real-time interception, the user is presented the current view of the existing GUI application executing in its native environment.

Referring to the right side of the Visual Editor 600 in FIG. 6B, a user of the Visual Editor 600 selects a target device from a list of available devices contained within Remote View 604. The list of available Remote View 604 devices includes, for example, mobile phones, tablets, etc. In this particular example, the target device is an iPhone. Once a Target Device 606 is selected, the user of the Visual Editor 600 can drag and drop one or more components from the Existing GUI Application 602 into the Remote View 604. Remote View 604 displays a preview of what the existing GUI application will look like once it has been decomposed and recomposed for the remote device. In some embodiments, the system has built-in templates for standard GUI components as described in herein.

The process of visually editing the application flow of the existing GUI application to generate an application definition targeted to a particular remote device of an embodiment of the present teaching begins by selecting one or more components from the existing GUI application on the left side of the Visual Editor 600 screen. Selecting the one or more components then reveals a set of tools available for the end user that assists with transferring the component to the target device. If the system can determine that the component is of a known type, for example, a text box or a button, it will suggest to the user a particular user interface template for that component to properly fit the remote device.

The user of the Visual Editor 600 then drags and drops the component into the target device on the right side of the screen. The target device simulates what that component will look like on the actual device. When the user clicks an element in the mobile screen, a context menu for that element is presented to the user. From this menu, the user of the Visual Editor 600 can perform various tasks, such as setting trigger/actions, specifying the component template, changing the style and changing the component settings, such as column order, text etc.

In some embodiments of the present teaching, the target device, such as a mobile device, has limited screen real estate. In these embodiments, it is useful for the user of the Visual Editor 600 to have the ability to edit the user flow by creating multiple screens out of one existing GUI window. If the original application has numerous form fields, lists and other components laid out in a vertical flow, the original window can be broken up into a plurality of logical screens, where each logical screen contains a part of the original window from the existing GUI application.

In some embodiments, the user desires to deliver a Task List Window 608 to a mobile computing device, such as an iPhone. The Task List Window 608 will be displayed as a data grid on the Target Device 606. Through the use of real-time interception, the existing GUI application is then loaded into the Reddo Adaptive UX Planner 122 that was described in connection with FIG. 1. A user creates a screen as a preview of the target device. The Task List from the visual editor is then dragged from the left side showing the Original GUI Application 602 into the Remote Device Preview Box 614. The interface automatically recognizes the component as a data grid, and the transformed component will retain all the row and column configuration information of the original. If desired, the user can edit the transformed component and remove or re-arrange the columns to provide the desired functionality. In this specific example, the mobile task list retains only a partial record. To view the full customer record, the mobile computing device user selects the task from the task list by tapping, which causes the full task record is be populated on a new screen.

In some embodiments, the user can add a component to the Remote View 604 not present within the Existing GUI Application 602. Possible components may include buttons, labels or navigation aids. In these embodiments, the user selects a new widget from an available list and drags and drops the components to the Remote View 604. The user can also add a new event to an existing or new component, where the new event is not present within the Existing GUI Application 602.

Once the user has completed the visual editing, the application definition is stored in a database within the Reddo Adaptive UX Planner 122 (FIG. 1). The application can then be delivered to the remote devices through various embodiments of the present teaching.

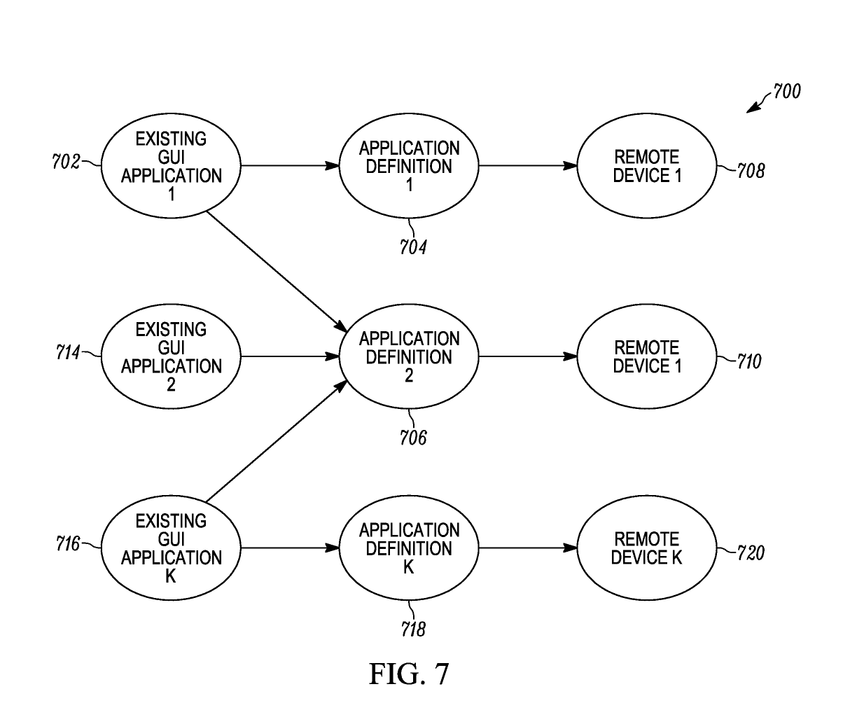

FIG. 7 illustrates a diagram 700 of how various application definitions can be used according to the methods and apparatus of the present teaching. In one embodiment of the present teaching, a particular existing GUI application is used in multiple application definitions for different remote devices. For example, the Existing GUI Application 1 702 can be used with both Application Definition 1 704 and Application Definition 2 706 where Application Definition 1 704 is targeted to Remote Device 1 708 and Application Definition 2 706 is targeted to Remote Device 2 710.

In another embodiment of the present teaching, two or more existing GUI applications share the same application definition. For example, Application Definition 2 706 is defined by Existing GUI Application 1 702, Existing GUI Application 2 714, and by Existing GUI Application k 716, where each of Existing GUI Application 1 702, Existing GUI Application 2 714, and Existing GUI Application k 716 are targeted to Remote Device 2 710. Existing GUI Application k 716 is associated with Application Definition k 718, which is targeted to Remote Device k 720. In some embodiments of the present teaching, pieces from a plurality of existing GUI applications are combined or “mashed-up” into one application definition.

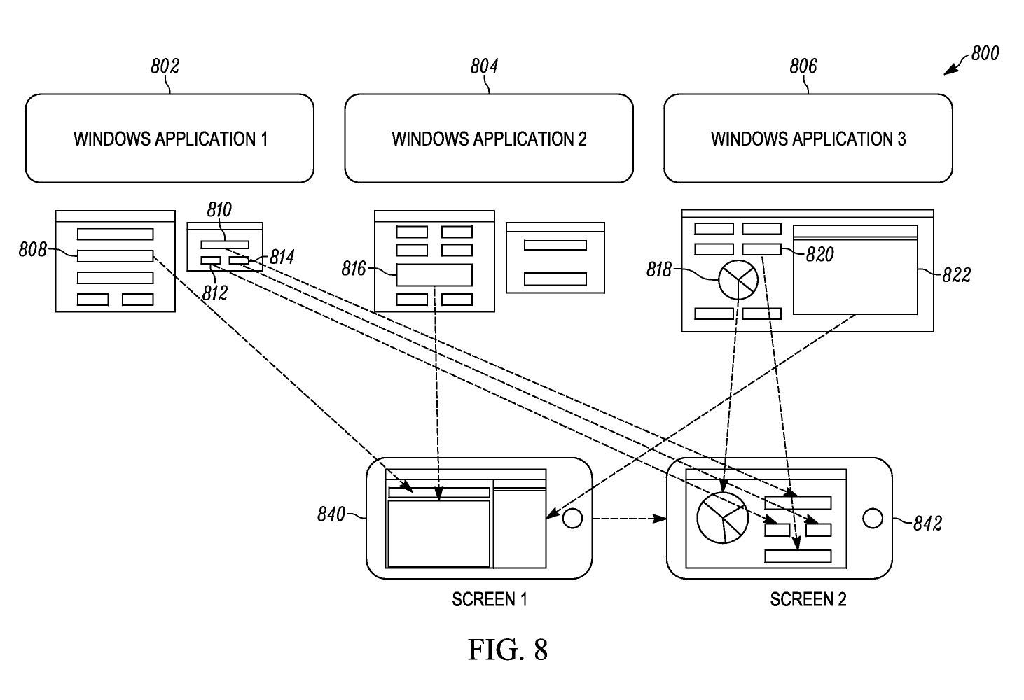

FIG. 8 illustrates a block diagram 800 of an embodiment of a method of the present teaching where components from multiple existing GUI applications are “mashed-up” to create one application definition. Two remote screens are shown in FIG. 8, Remote Screen 840 and Remote Screen 842. Each of the two Remote Screens, 840, 842 contains GUI elements from three existing GUI applications. In this particular embodiment, the existing GUI applications are Windows Application 802, Windows Application 804, and Windows Application 806. However, one skilled in the art will appreciate that the present teaching is not limited to Windows applications or any other particular type of GUI application.

The application definition that describes Remote Screen 840 and Remote Screen 842 can be created using the Reddo Adaptive UX Planner, which was described in connection with FIG. 6. In this example, components from their respective existing GUI applications are targeted for a particular remote device. The remote device encapsulating Remote Screen 840 and Remote Screen 842 is an Apple iPhone. However, one skilled in the art will appreciate that the present teaching is not limited to Apple iPhones or any particular type of computing device.

Windows Application 802 contains four GUI widgets that are targeted for Remote Screen 840 and Remote Screen 842. The GUI widgets are GUI Panel 808, GUI Panel 810, GUI Panel 812, and GUI Panel 814. Windows Application 804 contains one GUI widget that is targeted for Remote Screen 840. The GUI Widget is GUI Panel 816. Windows Application 806 contains three GUI widgets that are targeted for Remote Screen 840 and Remote Screen 842. The GUI widgets are GUI Chart 818, GUI Panel 820 and GUI Grid 822.

Remote Screen 840 is a rendering including one component from each of three existing GUI applications. The GUI Panel 808 is positioned on the top left side of Remote Screen 840. GUI Panel 816 is positioned on the bottom left side of Remote Screen 840, and takes up the available height within the viewport. Finally, GUI Grid 822 is positioned on the right side of Remote Screen 840, taking up the full height within the viewport.

Remote Screen 842 is a rendering consisting of multiple components from two existing GUI applications, Windows Application 802 and Windows Application 806. GUI Chart 818 is positioned on the left side of Remote Screen 842, centered vertically within the viewport. GUI Panel 820 is positioned on the bottom right of Remote Screen 842. GUI Panel 810 is positioned on the top right side of Remote Screen 842. GUI Panel 812 is positioned in the center of Remote Screen 842. Finally, GUI Panel 814 is positioned to the center right of Remote Screen 842.

### EQUIVALENTS

While the Applicants' teaching is described in conjunction with various embodiments, it is not intended that the Applicants' teaching be limited to such embodiments. On the contrary, the Applicants' teaching encompass various alternatives, modifications, and equivalents, as will be appreciated by those of skill in the art, which may be made therein without departing from the spirit and scope of the teaching.

We claim:

1. A method for delivering an existing GUI application executing on a local computing device to a remote device where application flow of the existing GUI application is customized to match constraints of the remote device, the method comprising:
a) providing an agent that deconstructs the existing GUI application on the local computing device in order to create an application representation model that describes the existing GUI application on the local computing device;
b) creating an application definition by visually editing the application flow of the deconstructed existing GUI application via real time interception of the existing GUI application to match constraints of the remote device; and
c) delivering the existing GUI application transformed by the application definition to the remote device utilizing a native widget toolkit of the remote device.

2. The method of claim 1 wherein the existing GUI application is selected from the group consisting of windows desktop applications, accounting applications, enterprise resource planning applications, web browsing applications, customer relationship management applications, supply chain management applications, data centric applications, and line-of-business applications.

3. The method of claim 1 wherein the at least one remote device is selected from the group consisting of personal computing devices, handheld computing devices, mobile telephones, wearable computing devices, and tablets.

4. The method of claim 1 wherein the application flow is chosen from the group consisting of screen control, component layout, component settings, and look and feel.

5. The method of claim 1 further comprising creating an application definition by visually editing a layout of the existing GUI application to match constraints of the remote device.

6. The method of claim 5 wherein the layout is chosen from the group consisting of component position, component size, and component arrangement.

7. The method of claim 1 further comprising creating an application definition by visually editing a user experience of the existing GUI application to match constraints of the remote device.

8. The method of claim 7 wherein the user experience is chosen from the group consisting of component settings, styles, events, triggers, actions, screen geometries, and navigation.

9. The method of claim 1 wherein the constraints of the remote device are chosen from the group consisting of physical screen size, screen resolution, screen dot pitch, user interface, keyboard size, and touch screen parameters.

10. The method of claim 1 wherein the visually editing the application flow of the existing GUI application is selected from the group consisting of resizing components, adding screens, editing styles, setting triggers, setting actions, customizing navigation, and selecting viewable components.

11. The method of claim 1 wherein the agent reads user interface behaviors selected from the group consisting of events, operating system API calls, operating system messages, and graphical changes.

12. The method of claim 1 wherein the agent comprises bidirectional communications that simulate activity on the existing GUI application.

13. The method of claim 1 wherein the visually editing the application flow comprises editing with at least one of a drag and drop methodology, a keyboard entry, a mouse entry, and a touch screen entry.

14. The method of claim 1 further comprising adding a new GUI object to comply with constraints of the remote device to create an application definition.

15. The method of claim 1 further comprising adding a new GUI event to comply with constraints of the remote device to create an application definition.

16. The method of claim 1 further comprising providing access control.

17. The method of claim 1 further comprising monitoring users performing the method.

18. A method for delivering an existing GUI application executing on a local computing device to a remote device where user experience of the at least one remote device is customized to match constraints of the remote device, the method comprising:
a) providing an agent that deconstructs the existing GUI application on the local computing device in order to create an application representation model that describes the existing GUI application on the local computing device;
b) creating an application definition by visually editing the user experience of the deconstructed existing GUI application via real time interception of the existing GUI application to match constraints of the remote device; and
c) delivering the existing GUI application transformed by the application definition to the remote device utilizing a native widget toolkit of the remote device.

19. The method of claim 18 wherein the user experience is chosen from the group consisting of component settings, styles, events, triggers, actions, screen geometries, and navigation.

20. The method of claim 18 further comprising adding a new GUI object in the existing GUI application to comply with constraints of the remote device to create an application definition.

21. The method of claim 18 further comprising adding a new GUI event in the existing GUI application to comply with constraints of the remote device to create an application definition.

22. The method of claim 18 further comprising creating an application definition by visually editing a layout of the existing GUI application to match constraints of the remote device.

23. The method of claim 22 wherein the layout is chosen from the group consisting of component position, component size, and arrangement.

24. The method of claim 22 wherein the visually editing the application flow of the existing GUI application is selected from the group consisting of resizing components, adding screens, editing styles, setting triggers, setting actions, customizing navigation, and selecting viewable components.

25. The method of claim 18 further comprising creating an application definition where application flow of the remote device is customized to match constraints of the remote device.

26. The method of claim 25 wherein the application flow is chosen from the group consisting of screen control, component layout, component settings, and look and feel.

27. The method of claim 18 wherein the existing GUI application is selected from the group consisting of word processing applications, accounting applications, enterprise resource planning applications, and web browsing applications.

28. The method of claim 18 wherein the remote device is selected from the group consisting of personal computing devices, handheld computing devices, mobile telephones, wearable computing devices, and tablets.

29. The method of claim 18 wherein the agent reads user interface behaviors selected from the group consisting of events, windows API calls, windows messages, and graphical changes.

30. The method of claim 18 wherein the agent comprises bidirectional communications that simulate activity on the existing GUI application.

31. The method of claim 18 wherein the visually editing the user experience comprises editing with at least one of a drag and drop methodology, a keyboard entry, and a touch screen entry.

32. The method of claim 18 further comprising adding a new GUI object to comply with constraints of the remote device to create an application definition.

33. The method of claim 18 further comprising adding a new GUI event to comply with constraints of the remote device to create an application definition.

34. The method of claim 18 further comprising providing access control.

35. The method of claim 18 further comprising monitoring users performing the method.

36. The method of claim 18 further comprising adding a new GUI object or event to comply with constraints of the at least one remote device to create an application definition.

37. A method for delivering a plurality of simultaneously executing GUI applications on at least one local computing device to a unified application on a remote device, the method comprising:
a) providing a plurality of agents that deconstruct each of the respective plurality of simultaneously executing existing GUI applications on the at least one local computing device in order to create an application representation model that describes each of the respective plurality of simultaneously executing GUI applications on the computing device;
b) creating an application definition by visually editing at least one of an application flow, a layout, and a user experience of the deconstructed existing GUI application via real time interception of the plurality of simultaneously executing GUI applications to match constraints of the remote device; and
c) delivering the existing GUI application transformed by the application definition to the remote device utilizing a native widget toolkit of the remote device.

38. The method of claim 37 wherein the plurality of simultaneously executing GUI applications are executed on one local computing device.

39. The method of claim 37 further comprising adding a new GUI object or event not present in the existing GUI application to comply with constraints of the remote device to create an application definition.

40. The method of claim 37 further comprising combining elements from several existing GUI applications to compose a single application definition.

41. The method of claim 37 wherein the application representation model describes at least two of the respective plurality of simultaneously executing GUI applications on the computing device.
